(19) United States
(12) Patent Application Publication
(10) Pub. No.: US 2002/0003965 A1
(43) Pub. Date: Jan. 10, 2002

(54) Method and apparatus for calibrating a camera

(76) Inventors: David Landelle, Bois D'Arcy (FR); Olivier Gafsou, Reims (FR); Mathias Bejanin, Paris (FR)

Correspondence Address: LARSON & TAYLOR, PLC, 1199 NORTH FAIRFAX STREET, SUITE 900, ALEXANDRIA, VA, 22314, US

(21) Appl. No.: 09/885,440

(22) Filed: Jun. 21, 2001

(30) Foreign Application Priority Data
Jun. 23, 2000 (FR) 00 08076

(51) Int. Cl. G03B 1/00

(52) U.S. Cl. 396/661

(57) ABSTRACT

Calibration of a camera lens involves two stages. A first stage involves determining intrinsic characteristics of the lens system and generating a computer file containing these characteristics. The first stage is performed once for all. In a second stage, performed each time a camera is used on site with the lens, there is on-site calibration of a package comprising the camera and a lens system is performed in order to define transfer functions between signals from sensors sensing the orientation of the camera and sensors sensing the setting of the lens system and the real characteristics, based on the file and on signals obtained by shooting characteristic points in the scene to be displayed.

### BACKGROUND OF THE INVENTION

The invention relates to camera lens systems having optical characteristics (such as zoom and focus) that can be modified while the camera is in use; the lens system is for mounting on a camera that is “instrumented”, i.e. having its own sensors for delivering signals representative of the angular position of the camera relative to its stand. A particularly important, although not exclusive, application of the invention lies in lens systems for use with cameras that are incorporated in installations that are capable of replacing the representation of a target zone in the image supplied by the camera and occupying a fixed position in the space viewed by the camera with a stored “model” or pattern that can be still or animated, and with the model being scaled appropriately. The position and the area of the fixed zone are stored in the installation which includes computation means and image synthesis means capable of computing the deformation or “warping” that need be imparted to the model, and capable of superimposing the warped model.

In general, the sensors used are digital encoders having the advantage of suffering no drift and of delivering an output that is directly usable by data processing equipment.

Installations of the above type already exist. To obtain satisfactory precision, implementation of such installations requires a lengthy and arduous calibration stage to be performed on site prior to shooting, during which a camera operator aims successively at various different portions of the entire space that can be scanned while using different degrees of zoom and a plurality of different focus settings, and the various sensors are calibrated from the shots using close and far fixed characteristic points in the observed scene as references. Those methods restrict the field of operation.

Other parameter measurement systems are known and for instance reference may be made to the paper “A high precision camera operation parameter measurement system and its application to image motion inferring” by Zheng et al, in “Proceedings of International Conference on Image processing, ICIP '99, Kobe, Japan, to which reference may be made.

### SUMMARY OF THE INVENTION

The inventors have become aware that some of the transfer functions and characteristics to be identified are intrinsic to the lens system itself, whereas others depend on the interface between the lens system and the camera and can be referred as being “extrinsic”. In particular, a given lens will not always be in exactly the same position relative to the camera's focal plane that is occupied by the array of photosensitive sites, due to inevitable tolerance (wear) assembly conditions, and image standards.

On the basis of these observations, it is an object of the invention to simplify quite considerably the operations that need to be performed on site each time a new camera or a new location is used.

To do this, the invention provides in particular a calibration method comprising the steps of

calibrating, once for all, intrinsic characteristics or parameters of the lens system and establishing a computer file containing said characteristics; and

on site, calibrating the assembled camera and lens system so as to define transfer functions between signals coming from camera orientation sensors and lens system sensors and real characteristics on the basis of said file and of signals obtained by shooting characteristic points of the scene to be observed.

In another aspect, a calibration method is proposed enabling a correspondence table to be determined between at least the output signals from zoom and focusing sensors Z and F placed on a camera lens and constituted by digital coders with real values for focal length and geometrical deformation, the method comprising:

(a) a step, that is performed once for all, of determining the intrinsic characteristics of the lens; and

(b) a step, that is performed on site after the lens has been mounted on a camera for a particular purpose, of resetting origins.

This greatly simplifies on-site operations since they can be reduced to taking a few shots that can be performed in a few minutes by an operator who has been trained but is not a specialist, with all of the intrinsic characteristics of the lens system being already available. The lens system calibration file need merely be selected, the constants of the system (type of camera head, position of camera on camera head) be given, and then the necessary shots be taken. In addition, this method provides great accuracy since intrinsic calibration is performed free from operating constraints.

The invention also proposes an assembly or package that can be used for use of a camera lens which constitutes said lens system, the assembly comprising the lens itself plus a file (ROM file, flash memory, disk) accompanying it and loadable into a computer used during the on-site portion of calibration.

The invention also provides software that can be executed on a computer and that includes a database containing the intrinsic characteristics of a lens system and a program responsive to the database and to measurements performed on site while the lens system is mounted on a camera to determine the extrinsic characteristics and the complete two-dimensional (2D) transfer function between the scene as seen by the camera and the displayed image.

In another aspect of the invention, there is provided a calibration method enabling a correspondence table to be established between at least the output signals from zoom and focus sensors Z and F placed on a camera lens and constituted by digital coders, and real values of focal length and geometrical deformation for the camera on which the lens system is mounted, the method comprising:

(a) a stage performed once and for always, of determining the intrinsic characteristics of the lens, which stage is performed after the lens has been mounted on a camera, and during which the following steps are performed:

taking a plurality of shots with the camera in different pan and tilt orientations and different zoom and focus values (where focus influences focal length);

for each shot, reading output signals from the coders and the positions in the image of at least two points, a near point and a far point, in the scene observed in the shot; and

drawing up an intrinsic calibration table by comparing the signal values and the positions of the points in the image provided by the camera; and

(b) a stage performed on site after the lens has been mounted on a camera that is to be used on site, during which stage, the following steps are performed:

specifying operating conditions (for example: PAL, NTSC, . . . , standard; 4/3 or 16/9 image ratio, high definition, . . . image size; camera position on the camera head after balancing, etc.); and

repeating only some of the operations performed in stage (a), solely insofar as they are necessary for resetting origins and for determining parameters including the pixel aspect ratio.

The near point observed during stage (a) could be provided by a point source such as a light emitting diode (LED) or a laser diode placed at a distance that is slightly greater than the nearest focus distance. The far point must simulate viewing at infinity and is preferably at least 100 meters (m) away.

In general, all of the measurements in stage (a) should be performed prior to performing the computations which are subsequently performed globally either on site or remotely. For example, these measurements can be performed using a program that is well defined as a plurality of steps, each step being performed with the same zoom setting, and a plurality of different focus settings.

The independence between the zoom and focus characteristics then makes it possible to represent the lens by a mathematical model in the form of two tables representing two families of functions each having a single input variable, whereas an approach without separation would have required a table with two input variables which would make interpretation difficult. In other words, the lens is represented by a mathematical model using single input variable functions only.

An additional advantage of the method is that it makes remote calibration possible so there is no need to disclose the calibration software, and that would be impossible without the last two steps of stage (a) being separated. An application server can be provided using the SMTP protocol, while the calibration machine is connected temporarily to the Internet. For the purposes of an Internet connection, the data obtained by the “snaps” mentioned below are sent to a server which responds by sending a calibration file which can optionally be encrypted.

The camera fitted with the lens can be associated with at least one gyrosensor (gyro or rate gyro) which provides angle measurements in addition to those supplied by the camera head sensors, e.g. when the camera head is subjected to vibration (as in a stadium). The gyro is for measuring tilt for which out-of-balance weight can give rise to measurement errors. The camera is balanced statically but not dynamically: so long as it is not in motion, it is balanced, but under the effect of excitation (for the most part along the vertical axis if the structure is sound) translation motion gives rise to tilt rotation. On a structure having resonant modes that are more troublesome, for example horizontal translation motion, it is possible to envisage a second gryosensor responsive to pan.

The data originating from the sensors representing the state of the instrumented camera can be used directly in conventional manner or can be converted into an audio frequency signal, thereby making it possible to use the ordinary audio-visual environment for data transport and/or recording.

The above characteristics and others will appear more clearly on reading the following description of a particular embodiment given by way of non-limiting example. The description refers to the accompanying drawings.

### BRIEF DESCRIPTION OF THE DRAWINGS

FIG. 1 is a diagram showing the functions of the various sensors carried by the lens and the head of an instrumented camera intended for enabling a target zone to be substituted;

FIG. 2 shows a common way of mounting a camera head, in which tilting movements are added to pan movement (in contrast to a so-called “equatorial” mount);

FIGS. 3A and 3B show types of deformation that occur when an image is formed;

FIG. 4 shows locations in which the same scene reference point is placed for initial intrinsic calibration and subsequently for extrinsic calibration; and

FIG. 5 is a simplified summary chart showing one possible way in which the mathematical model can be implemented.

### DETAILED DESCRIPTION OF THE INVENTION

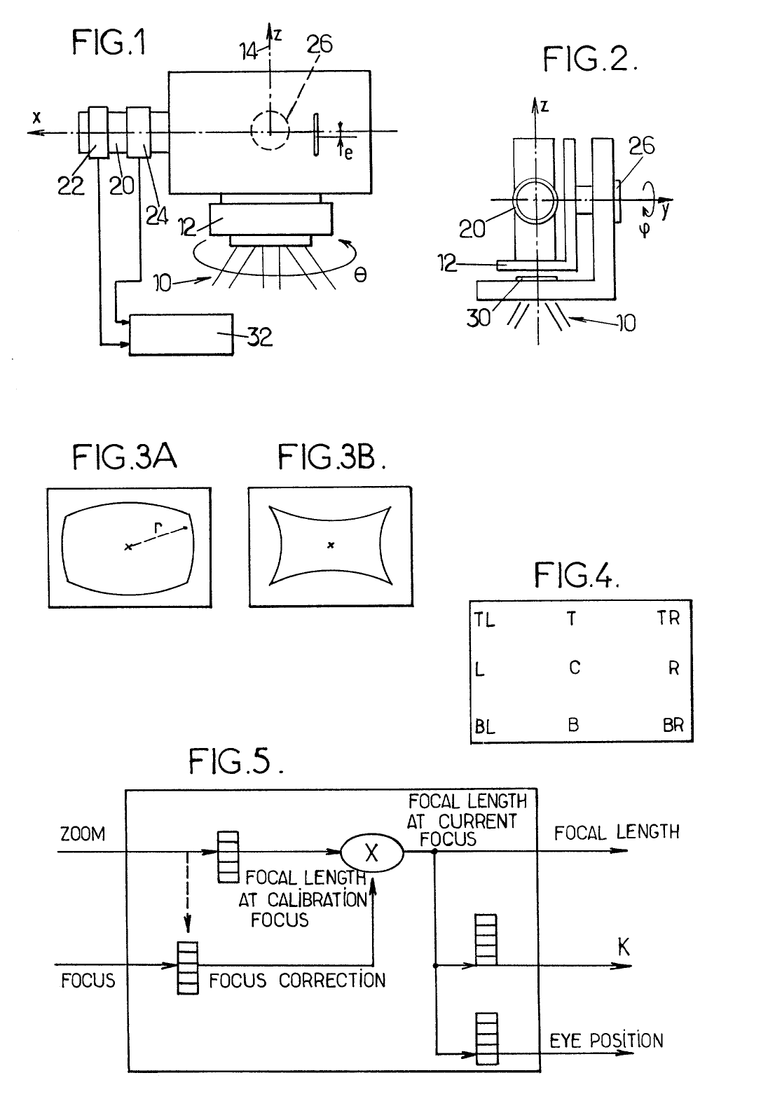

The camera shown diagrammatically in FIG. 1 comprises a stand 10 on which a head support 12 can turn about a pan axis 14. The head 16 can turn relative to the support 12 about a tilt axis 18. On the camera head there is mounted a lens 20 which generally carries a focusing ring 22 and a zoom ring 24. These two rings are provided with respective absolute angle encoders of high resolution. The tilt angle φ relative to the support is provided by a sensor 26. The angle θ about the pan axis is supplied by a sensor 30. All of these sensors are connected to acquisition electronics 32 which converts the data form the sensors into the form of a serial signal (RS232, RS422) or into audio modulation.

In order to ensure that inlaying can be performed precisely, it is necessary to use the signals from the sensors to determine exactly where the target zone for replacement is to be found in the image, which zone remains motionless within the scene, and it is necessary to do so regardless of camera zoom, focus, or orientation. Unfortunately, image transformations when these parameters are combined are far from being simple homothetic transforms, and they are far from being the same for all lenses of a same type.

Calibration is a deterministic process, thus making it possible to store the behavior of the lens for all zoom and focus positions.

The following are described below in succession:

intrinsic calibration: this generates a file containing the intrinsic geometrical characteristics of the lens; the lens is then entered into a database of calibrated lenses; calibration needs to be done for each lens, even for lenses of the same model and from the same manufacturer, but on each lens it need be done only once and for always; and

extrinsic calibration known as lens camera setting (LCS): it takes account of operating constraints associated with the lens being mounted and dismounted on a particular camera giving rise to alignment differences which occur with a single camera and with different cameras (image format). LCS needs to be performed each time a lens is mounted on a camera, even if the same lens is newly mounted on the same camera (mechanical tolerances).

Once operations have been performed, the behavior of the camera used for shooting will have been stored for an entire series of values delivered by the zoom sensor Z and the focus sensor F, thus making interpolation possible.

Intrinsic Calibration, Transposable From One Camera To Another

The lens is modelled by defining a plurality of parameters that vary as a function of its focal length f at least:

absolute focal length for two known distance values of the target points, one being at infinity P1 and the other point, P2, being nearby (in the range 5 m to 15 m, depending on the type of lens);

a coefficient K representing geometrical deformation in the radial direction; and

a focal length correction associated with the focus setting;

and global parameters that are independent of zoom:

position of the eye;

aspect ratio (pixel height/width ratio in the matrix of light sensitive sites); and

tilt while taking a horizontal shot because the tilt coder does not give a zero value under such circumstances.

The position of the eye is a point on the optical axis such that if it is caused to coincide with the vertical or pan axis, then no parallax is visible in the image when panning between a near point (e.g. as implemented on a pane of glass) and a point at infinity.

Initialization, Wide Angle And Narrow Angle

The operation begins by entering the identity of the lens into memory.

P1 and P2 are selected points;

F1 and F2 are focus values at full zoom Zn (maximum magnification or zoom in) selected for P1 and P2;

F3 is a focus value selected arbitrarily between 1.1 F2 and the value of F at the nearest focus distance, Z1, . . . , Zi, . . . , Zn being reference zoom values;

T, B, L, R, C, TL, BR, TR, BL being the nine positions that a given point is caused to occupy in the image by manipulating the camera (FIG. 4),

the operator begins by performing six initialization operations. During each such operation, referred to as a “nsnap”, the operator moves the camera so as to bring the point under observation into one of the nine above-mentioned positions, and clicks on the point. On each occasion, the values supplied by the coders and the distance between the points in the scene and the camera are stored:

P1, F1, Zn, C

P1, F1, Z1, C

P1, F1, Z1, L

P1, F1, Z1, R

P2, F2, Zn, C

P1, F1, Z1, B

No computation is performed at the end of this stage; the operator then moves onto measurements at wide angle (zoom out) Z1 and narrow angle (zoom in) Zn.

Wide And Narrow Angles, Corresponding To Different Focal lengths, with focusing F1, F2, and F3

The operator takes five snaps to define the wide angle condition:

P1, F1, Z1, T

P1, F1, Z1, TL

P2, F1, Z1, T

P2, F2, Z1, T

P2, F3, Z1, T

and then five snaps in narrow angle:

P1, F1, Zn, H

P2, F1, Zn, TL

P2, F1, Zn, T

P2, F2, Zn, T

P2, F3, Zn, T

At the end of this stage, the software runs a first series of computations, initially giving default values to global parameters:

DO

{DETERMINE Z1 ZOOM PARAMETERS FROM THE 5 Z1 SNAPS

DETERMINE Zn ZOOM PARAMETERS FROM THE 5 Zn SNAPS

DETERMINE GLOBAL PARAMETERS FROM THE 6 D SNAPS INITIALIZATION}

UNTIL CONVERGENCE

If there is no convergence, the software is designed to ask the operator to verify the snaps or to do them again.

The results of all the above snaps and of the following snaps are stored in the computer memory in order to enable the operator to return to the position of some particular point, if the operator so desires.

By way of example, a “snap” can cause a 200 pixel×150 pixel window to be scanned in the full image, corresponding to about 60 k.

Intermediate Zooms

Measurements are performed at various intermediate amounts of zoom Z2, Z3, . . . , Zn-1. For each reference zoom, the operator takes five more snaps:

P1, F1, Zi, T

P1, F1, Zi, TL

P2, F1, Zi, T

P2, F2, Zi, T

P2, F3, Zi, T

At the end of this step, the software computes zoomrelated parameters for each of the values Zi. The software is designed to ask the operator to verify the snaps or to start again if convergence does not occur.

The most important point is focal length which varies as a function of zoom, and to a lesser extent focus. Focal length makes it possible to conserve a relationship between image points and coordinates in three-dimensional (3D) space.

Each computation step makes it possible to define a parameter of the lens by a sequence in which:

only previous parameters are necessary;

parameters that are still unknown do not vary.

These steps comprise in succession:

1) determining the optical center of coordinates (Cx, Cy) on the matrix due to the offset e;

2) aspect ratio =Ypixel/Xpixel for the reference camera;

3) absolute focal length, which is a function of zoom for constant focus;

4) focus correction having the form 1+ε(Focus) where ε(Focus)=A×Focus²+B×Focus+C; and

5) the radial distortion coefficient K that is involved in a formula of the form r′=r+Kr³;

where r is the distance to the optical center and K is a function solely of the focal length, and is positive for barrel deformation and negative for pin-cushion deformation.

A distinction is made between:

constant parameters

position of the optical center

aspect ratio or “pixel ratio”

absolute focal length scale; and

parameters that are a function of zoom

focal length

K

focus connection

eye position.

In order, the following are determined:

the fixed parameters;

curves of:

focal length (zoom) at constant focus;

K (of focal length) at constant focus;

eye position (focal length) at constant focus; and

focus correction (focal length).

The analytical expressions found experimentally are piece-wise logarithmic for zoom over each range between two values Zi and they are polynomials of order 2 for focus correction. They are stored in the form of particular values for parameters in a mathematical model.

Once intrinsic calibration has been performed, the results of the processing performed locally or on a remote server are stored in the form of a file in a read-only memory (ROM) or in a flash memory, or on a hard disk.

A file is then available which contains calibration parameters that are as close as possible to the real characteristics of the lens.

Extrinsic Calibration

When the lens is mounted on a camera other than the reference camera on which its intrinsic characteristics were determined, there will be a small change in optical center, and this gives rise to errors. Camera balancing moves the “eye position” and gives rise to a parallax effect (camera rotation gives rise to a small amount of movement in translation of unknown sign) which is most troublesome when the object is close. Finally, the image sensor can be of geometry and size that are different depending on image standard.

Extrinsic calibration, which can also be referred to as lens camera setting or LCS, amounts to adjusting calibration data. It does no more than recompute constant parameters associated with camera initialization, and including parameters that come from two sources:

lens-camera coupling:

optical center (Cx, Cy);

pixel ratio (Ypixel/Xpixel=pixel aspect ratio);

focal length scale adjustment (absolute focal length);

base plate offset adjustment (basis for eye position); and

adjustment of absolute focal length scale;

possibly also camera-head coupling (with multiple origins for each parameter):

roll: the horizontal axis of the matrix is at an angle with the tilt axis, adjustment of the offset of the camera baseplate on the stand; and

tilt zero: the value given by the tilt encoder when the optical axis is exactly orthogonal to the pan axis.

This list is not limiting, and other parameters could be incorporated:

pan zero (optical axis not exactly parallel to tilt axis)

focus zero (end stop unreliable on some lenses); and

zoom zero (end stop unreliable on some lenses).

In order to be able to provide the computer associated with the camera and a subsequent system for inserting a virtual model in the position of a target with elements enabling them to identify the exact location in the image where an insertion is to be performed, the on-site operator performs above operations 1 and 2 to identify the optical center and the aspect ratio and also to determine the absolute focal length. The computer containing the program associated with the lens resets the constant parameters as supplied by the file associated with the lens. A mathematical model is thus obtained that is of the kind shown in FIG. 5. In other words, the information provided by the sensors is corrected so as to enable the exact position of the target in the image as reproduced, thus enabling the target to be replaced by the model after the model has been scaled appropriately (and possibly also deformed due to perspective or to geometrical aberrations of the lens), or the model can be added to the target, in semitransparent form, after it has been scaled.

1. A method of calibrating a camera lens system having adjustable parameters as used on site on a camera provided with sensors for delivering signals representative of at least pan and tilt angles of the camera, the method comprising the steps of:
(a) calibrating, once for all, determining intrinsic characteristics of the camera lens system while it is mounted on a reference camera and establishing a computer file containing said intrinsic characteristics for obtaining a first calibration which is specific to the lens system and is carried out once for all; and
(b) further calibrating, on site, each time the lens system is used, an assembly comprising the on-site camera and the lens system mounted on the on-site camera so as to define transfer functions relating signals from said camera sensors and from lens system sensors delivering signals responsive to values of said adjustable parameters to actual values of said parameters, based on said file and of signals obtained by shooting predetermined characteristic points in a scene observed by the on-site camera

2. A calibration method for generating a correspondence table between at least output signals from zoom and focus sensors placed on a camera lens and constituted by digital encoders, and actual values of focal length and geometrical deformation for a camera on which the lens system is mounted, said method comprising:
(a) performing a stage once and for always, comprising determining intrinsic characteristics of the lens, which stage is performed after the lens has been mounted on a camera, and comprising the following steps:
taking a plurality of shots with the camera in different pan and tilt orientations and different zoom and focus values for obtaining respective successive images,
for each shot, storing output signals from the encoders and positions in the image of at least two points, including a nearer point and a farther point in a scene observed in the shot; and
drawing up an intrinsic calibration table by comparing values of the output signals and the positions of the points in the images by the camera; and
(b) a stage performed on site after the lens has been mounted on a camera to be used on site, comprising the steps of:
specifying operating conditions; and
repeating only some of the operations performed in stage (a) solely insofar as they are necessary for resetting origins.

3. A method according to claim 1, wherein the nearer point observed during stage (a) is a point source.

4. A method according to claim 3, wherein the point source is a laser diode placed at a distance that is greater than and close to a shortest distance for which focussing is possible.

5. A method according to claim 1, characterized in that all of the measurements of stage (a) are performed prior to performing all computations which are later performed subsequently and together.

6. A method according to claim 2, wherein during calculations the lens is represented by a mathematical model making use solely of functions having a single input variable.

7. A method according to claim 2, comprising the steps of converting a set consisting of all data delivered by the sensors and representing a condition of the instrumented camera into an audio signal, and transporting and recording said set in an audio-video environment.
